(19) United States
(12) Patent Application Publication
(10) Pub. No.: US 2009/0166427 A1
(43) Pub. Date: Jul. 2, 2009

(54) Authentication/security labels and associated method containing photochromic inks

(76) Inventor: Jeffrey Allen Chambers, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/286,412

(22) Filed: Sep. 30, 2008

Related U.S. Application Data
(60) Provisional application No. 61/016,827, filed on Dec. 27, 2007.

(51) Int. Cl. G06K 7/12; G06K 19/00

(52) U.S. Cl. 235/468; 235/487

(57) ABSTRACT

An authentication label and associated method are disclosed that can be covert most of the time and made to be overt only during times immediately before, during, and/or after reading of the label by a reader. The label contains a photochromic ink.

### CROSS-REFERENCE TO RELATED APPLICATION

This application claims priority under 35 U.S.C. §119 from U.S. Provisional Application Ser. No. 61/016,827 (filed Dec. 27, 2007), the disclosure of which is incorporated by reference herein for all purposes as if fully set forth.

### BACKGROUND OF THE INVENTION

1. Field of the Invention

The invention generally relates to systems for authenticating articles, methods for authenticating articles, and processes for marking articles for later authentication. The present invention more particularly relates to the use of photochromic inks in authentication systems.

2. Description of Related Art

Two patents in this general art area are U.S. Pat. Nos. 7,124,944 and 7,147,801.

### SUMMARY OF THE INVENTION

In an embodiment, the invention is a covert/overt authentication method comprising:
a) printing textual information on an article using a photochromic ink having a spectral bandwidth;
b) illuminating the textual information with electromagnetic radiation;
c) reading the textual information with a scanner to process the textual information and to thereby verify authenticity of the article; and
d) extinguishing the illumination in step b) such that the photochromic ink fades back to invisibility.

In another embodiment, the invention is an authentication/security label comprising:
a) a substrate; and
b) a photochromic ink that absorbs in the visible red region of the electromagnetic spectrum.

### DETAILED DESCRIPTION

The invention provides a covert means of adding information (e.g., barcodes) which are difficult to detect by the unaided human eye, but can be read by standard barcode scanners, by means of printing the barcode with clear-to-colored photochromic dyes, which change color reversibly on illumination with ultraviolet light.

This invention utilizes a photochromic dye that is dissolved in an ink vehicle to afford a photochromic ink that is used for printing textual information.

For sake of simplicity, the word “code” is used generally herein to indicate any encrypted or unencrypted means of conveying information through printed indicia.

In this invention, a photochromic dye-containing ink is used to print encrypted information, such as in a barcode. Photochromic dyes have the property of being colorless until they are illuminated with some excitation, such as ultraviolet light. In the absence of suitable excitation, codes printed with inks containing photochromic dyes are substantially invisible to the unaided eye. While illuminated with ultraviolet light, and for a short period of time thereafter, the selected photochromic dyes turn colors which can be detected by the human eye or by a scanner means. After the illumination is extinguished, the color of the photochromic dye fades over a period of a few seconds to a minute, and becomes once again unreadable by the scanner means and substantially invisible to the human eye. This effect is entirely reversible and once printed, the invisible-to-readable-to-invisible code reading cycle can be repeated many times.

The invention can be embodied in several ways (as discussed below).

In the discussion below, a ‘suitable color’ is one which can be readily detected by a barcode scanner. Most scanners are monochrome readers, and the color they ‘see’ in is red, either 632 nm for laser scanners or 650 nm for LED scanners. Those familiar with color theory understand that colors such as blue or green appear black when illuminated only with red light, and yellows and oranges appear as bright (white to the unaided eye) colors. Thus, a blue code (e.g., barcode) on a yellow background will appear to a scanner as a ‘black and white’ image appears to humans. In general, a change of contrast of 25% is necessary for a barcode scanner to recognize the pattern.

On white (or yellow or orange) backgrounds, just the code (e.g., barcode) or indicia may be printed with photochromic dyes of suitable color (blue, green or black) in a suitable ink vehicle. An unmodified barcode scanner may be used by providing a separate UV illumination source such as a UV lamp or LED device to induce the photochromic color change, followed by reading the code (e.g., barcode) with the scanner. A simple modification to the scanner might be to add the UV light source to the optical train of the scanner, or an attachment to the scanner head can easily be envisioned. Such an attachment might consist of one or more UV LEDs, a battery and resistor, and a switch to activate the illumination.

On dark (e.g. green, blue or black) substrates, printing a light reflective foreground field of everything except a code in a photochromic ink allows the underlying dark substrate background to appear as the code (e.g., barcode). An analogy would be viewing a black screen through a white picket fence, wherein the pickets appear as a white field and the space between the pickets appears as black bars. This code (e.g., barcode) can be read by any of the unmodified or modified scanners described above.

Finally, if the background color is unsuitable, both a light background and an overprinted dark set of bars can be provided.

A covert authentication method is provided when 1) a code (e.g., barcode) is printed on a target substrate by conventional means using a photochromic ink, 2) followed by illumination with the required excitation as described above, 3) the code is read by an appropriate, conventional scanner and the encrypted information processed, 4) the illumination is extinguished and 5) the photochromic code (e.g., barcode) fades back to invisibility.

The extinguishing step d) of the method includes, but is not limited to, allowing the photochromic ink to self-extinguish (decay)—i.e., to change back from being colored to being colorless or nearly so. This change can be due to the reverse of the original photochromic reaction occurring, which imparted the original change from colorless to colored.

In an embodiment of the authentication method, the electromagnetic radiation employed is ultraviolet radiation.

In an embodiment of the authentication method, the scanner is a conventional scanner that operates with red visible light.

In an embodiment of the authentication method, the extinguishing step d) is done as soon as the textual information has been read.

In an embodiment of the authentication method, the photochromic ink fades to invisibility within five minutes of initiating step d). In other embodiments of the authentication method, the photochromic ink fades to invisibility within one minute, 0.5 minute, 15 seconds, 10 seconds, 5 seconds, and 1 second of initiating step d).

In an embodiment of the authentication method, the electromagnetic radiation has a spectral bandwidth that overlaps the spectral bandwidth of the photochromic ink.

This invention satisfies the need to protect goods from being counterfeited or diverted.

The invention can be an enhancement to existing overt authentication devices, by allowing covert encryption of information onto a visual image without interfering with that image, until the need to decrypt the information is realized. The encrypted information can be caused, on demand, to be read visually or by means of a scanner, and then can revert to its covert state thereafter.

### EXAMPLES

### Example 1

This example illustrates an authentication/security label containing encrypted information (e.g., a barcode) that is covert except when the information is being read by a reader wherein electromagnetic radiation (e.g., ultraviolet light) is applied to convert the label to an overt state and hence make it readable. In this example, a substrate is used which provides a favorable contrast color for a barcode printed in a dark color. A photochromic dye, such as Oxford Blue from James Robinson Ltd of the United Kingdom, was added to an ink vehicle at a level of 5% of total solids and stirred until well mixed. This photochromic ink may be thickened as necessary with colloidal silica available from Sigma Aldrich of St. Louis Mo. to form a paste of viscosity suitable for screen printing, approximately 20,000 to 25,000 centipoise. This screen printing ink was applied to a screen with a suitable\barcode of any conventional barcode format. Such a screen is available from Sefar Printing Solutions of Arden Hills, Minn. A squeegee was drawn across the screen to print the barcode pattern onto the desired substrate, which in this example was white paper. The printed paper and ink were placed in an oven at 60° C. with a small pan of water to provide catalytic amounts of water vapor in the oven to facilitate curing of the ink. The barcode was substantially invisible to the unaided eye.

After curing, the printed barcode was illuminated with 365 nm excitation from a UV lamp, such as Model UVLMS-38 provided by UVP of Upland, Calif., until the color of the barcode was fully developed. Either during UV illumination or immediately thereafter, the barcode was scanned by a suitable barcode reader, which was Model LS 2208 available from Symbol Technologies, NY. After the barcode was recognized by the scanner, the UV illumination was removed, resulting in the barcode fading back to substantial invisibility (and hence again becoming covert).

### Example 2

In this example, a dark substrate provided a background favorable to providing contrast to a printed, bright foreground field. In this example, a clear to yellow photochromic ink was prepared using a photochromic dye such as Sunflower from James Robinson Ltd. of the UK, which was added to a suitable ink vehicle. This ink was screen printed, according to Example 1, as a substantially contiguous field which was substantially invisible to the human eye until illuminated by UV light as in Example 1, whereupon it turned yellow, with gaps provided in said field which 1) allowed the dark background field to show through, 2) wherein said gaps are sized and spaced to provide the textual information of a barcode when screen printed. This afforded a good image of a barcode upon exposure to UV light but it could not be read by the scanner of Example 1. It is believed that the particular screen used was too course to provide for detailed straight lines within the printed barcode that precluded reading the barcode.

### Example 3

In this example, the substrate does not provide a background favorable to providing contrast to the darker bars of the barcode. In this example, a clear to yellow photochromic ink was prepared using a photochromic dye such as Sunflower from James Robinson Ltd. of the UK, which was added to a suitable commercial ink vehicle. This ink was screen printed, according to Example 1, as a solid background which was substantially invisible to the human eye until illuminated by UV light as in Example 1, whereupon it turned yellow. Over this background, a barcode was printed according to Example 1. Illumination, scanning and returning to substantial invisibility was carried out according to Example 1. This afforded a good image of a barcode upon exposure to UV light but it could not be read by the scanner of Example 1. It is believed that the particular screen used was too coarse to provide for detailed straight lines within the printed barcode that precluded reading the barcode.

What is claimed is:

1. A covert/overt authentication method comprising:
a) printing textual information on an article using a photochromic ink having a spectral bandwidth;
b) illuminating the textual information with electromagnetic radiation;
c) reading the textual information with a scanner to process the textual information and to thereby verify authenticity of the article; and
d) extinguishing the illumination in step b) such that the photochromic ink fades back to invisibility.

2. The method of claim 1 wherein the electromagnetic radiation is ultraviolet radiation.

3. The method of claim 1 wherein the scanner is a conventional scanner that operates with red visible light.

4. The method of claim 1 wherein the extinguishing step d) is done as soon as the textual information has been read.

5. The method of claim 1 wherein the photochromic ink fades to invisibility within five minutes of initiating step d).

6. The method of claim 1 wherein the photochromic ink fades to invisibility within one minute of initiating step d).

7. The method of claim 1 wherein the electromagnetic radiation has a spectral bandwidth that overlaps the spectral bandwidth of the photochromic ink.

8. An authentication/security label comprising:
a) a substrate; and
b) a photochromic ink that absorbs in the visible red region of the electromagnetic spectrum.
